(19) United States
(12) Patent Application Publication
(10) Pub. No.: US 2009/0124365 A1
(43) Pub. Date: May 14, 2009

(54) METHOD AND APPARATUS FOR A BONUS GAME HAVING A PROGRESSIVE PRIZE

(76) Inventors: Andrzej Surmacz, Las Vegas, NV (US); Michael D. Frick, Crawfordville, FL (US); Robert J. Wright, Palm Beach Gardens, FL (US)

Correspondence Address: PATENT INGENUITY, PC, 520 BROADWAY, SUITE 350, SANTA MONICA, CA, 90401, US

(21) Appl. No.: 11/938,713

(22) Filed: Nov. 12, 2007

(51) Int. Cl. G06F 17/00

(52) U.S. Cl. 463/27

(57) ABSTRACT

An apparatus displays a plurality of distinct wager categories corresponding to play in a first game and a second game. Each of the distinct wager categories being associated with a known distinct portion of a jackpot prize associated with the second game. Further, the apparatus receives a selection of one of the distinct wager categories. In addition, the apparatus initiates play of the first game. The apparatus also initiates, after the play of the first game, play of the second game. Further, the apparatus determines a winning combination for the second game. In addition, the apparatus determines a player combination for the second game. The apparatus also provides the known distinct portion of the jackpot prize associated with the distinct wager category and also with the second game if the player combination matches the winning combination.

### BACKGROUND

1. Field

This disclosure generally relates to the field of gaming. More particularly, the disclosure relates to wagering for a game.

2. General Background

Various slot machine games provide some of the most popular forms of gaming. In particular, some slot machines offer a bonus game that is played after the base game. The use of the bonus game provides an added level of excitement for slot machine game players and potential slot machine game players. Further, the bonus game can offer a progressive jackpot prize, which can accumulate to be quite large, in order to further incentivize play at the slot machine.

However, the current approach limits play of the bonus game to only a portion of the players of the base game. The base game generally offers different wager categories, e.g., “one x”, “two x”, “three x”, “four x”, and “five x”, from which the player selects. The selected wager category is then multiplied by the minimum wager, e.g., one dollar, to determine the player's wager. For example, a selection of the wager category “three x” equals a wager by the player of three dollars. Each of those wager categories generally corresponds to a fixed prize that is typically far less than the jackpot prize, which can accumulate based on wagers. Only the players that provide the maximum wager, e.g., five dollars, are allowed to move on to the bonus round. Once the bonus round is reached, there is only one jackpot prize.

As a result, players having an interest in making a lower wager are discouraged from playing the base game. These players realize that their wagers are being utilized to contribute to a progressive jackpot prize in which they do not get to participate. Accordingly, the current approach to progressive slot machines actually discourages some potential players from playing the base game.

### SUMMARY

In one aspect of the disclosure, an apparatus displays a plurality of distinct wager categories corresponding to play in a first game and a second game. Each of the distinct wager categories is associated with a known distinct portion of a jackpot prize associated with the second game. Further, the apparatus receives a selection of one of the distinct wager categories. In addition, the apparatus initiates play of the first game. The apparatus also initiates, after the play of the first game, play of the second game. Further, the apparatus determines a winning combination for the second game. In addition, the apparatus determines a player combination for the second game. The apparatus also provides the known distinct portion of the jackpot prize associated with the distinct wager category and also with the second game if the player combination matches the winning combination.

In another aspect of the disclosure, a process is provided. The process displays a plurality of distinct wager categories corresponding to play in a first game and a second game, each of the distinct wager categories is associated with a known distinct portion of a jackpot prize associated with the second game. Further, the process displays a plurality of distinct paylines corresponding to prize payout in the first game. Each of the paylines indicates a distinct prize associated with a distinct symbol combination in the first game. In addition, the process receives a selection of one of the distinct wager categories. The process also determines a wager based on the wager category that is selected. Further, the process receives a selection of at least a subset of the plurality of distinct paylines. In addition, the process calculates the known distinct portion of the jackpot prize associated with the second game by multiplying a quantity of the distinct paylines in the subset of the plurality of distinct paylines with the wager. The process also initiates play of the first game. The process initiates, after the play of the first game, play of the second game. Further, the process determines a winning combination for the second game. In addition, the process determines a player combination for the second game. Finally, the process provides the known distinct portion of the jackpot prize associated with the distinct wager category and also with the second game if the player combination matches the winning combination.

In yet another aspect of the disclosure, a process is provided. The process displays a plurality of distinct wager categories corresponding to play in a first game and a second game. Each of the distinct wager categories is associated with a known distinct portion of a jackpot prize associated with the second game. Further, the process displays a plurality of distinct paylines corresponding to prize payout in the first game. Each of the paylines indicates a distinct prize associated with a distinct symbol combination in the first game. In addition, the process establishes a criterion for the first game as a condition for the play in the second game. The criterion is a display of one or more symbols during play of the first game. The process also receives a selection of one of the distinct wager categories. Further, the process determines a wager based on the wager category that is selected. In addition, the process receives a selection of at least a subset of the plurality of distinct paylines. The process also calculates the known distinct portion of the jackpot prize associated with the second game by multiplying a quantity of the distinct paylines in the subset of the plurality of distinct paylines with the wager. Further, the process initiates play of the first game. In addition, the process initiates, after the play of the first game, play of the second game if the criterion is met. The process determines a winning combination for the second game. Further, the process determines a player combination for the second game. In addition, the process provides the known distinct portion of the jackpot prize associated with the distinct wager category and also with the second game if the player combination matches the winning combination.

In another aspect of the disclosure, an apparatus is provided. The apparatus has a display that displays a plurality of distinct wager categories corresponding to play in a first game and a second game. Each of the distinct wager categories is associated with a known distinct portion of a jackpot prize associated with the second game. The apparatus has a wager input indicator that selects of one of the distinct wager categories. Further, the apparatus has a play input indicator that initiates play of the first game and initiates, after the play of the first game, play of the second game. In addition, one or more controllers that determine a winning combination for the second game, a player combination for the second game, and whether a match exists between the player combination and the winning combination so that a known distinct portion of the jackpot prize associated with the distinct wager category and also with the second game is provided to the player.

In yet another aspect of the disclosure, an apparatus is provided. The apparatus has a display that displays a plurality of distinct wager categories corresponding to play in a first game and a second game. Each of the distinct wager categories is associated with a known distinct portion of a jackpot prize associated with the second game. Further, the apparatus has a wager input indicator that selects of one of the distinct wager categories. In addition, the apparatus has a payline input indicator that performs a selection of at least a subset of the plurality of distinct paylines. The apparatus has a play input indicator that initiates play of the first game and initiates, after the play of the first game, play of the second game. Further, the apparatus has one or more controllers that determine a wager based on the wager category that is selected, calculate the known distinct portion of the jackpot prize associated with the second game by multiplying a quantity of the distinct paylines in the subset of the plurality of distinct paylines with the wager, determine a winning combination for the second game, determine a player combination for the second game, and determine whether a match exists between the player combination and the winning combination so that a known distinct portion of the jackpot prize associated with the distinct wager category and also with the second game is provided to the player.

In another aspect of the disclosure, an apparatus is provided. The apparatus has a display that displays a plurality of distinct wager categories corresponding to play in a first game and a second game. Each of the distinct wager categories is associated with a known distinct portion of a jackpot prize associated with the second game. The apparatus has a wager input indicator that selects of one of the distinct wager categories. Further, the apparatus has a payline input indicator that performs a selection of at least a subset of the plurality of distinct paylines. In addition, the apparatus has a play input indicator that initiates play of the first game and initiates, after the play of the first game, play of the second game. The apparatus has one or more controllers that establish a criterion for the first game as a condition for the play in the second game, determine a wager based on the wager category that is selected, calculate the known distinct portion of the jackpot prize associated with the second game by multiplying a quantity of the distinct paylines in the subset of the plurality of distinct paylines with the wager, determine a winning combination for the second game, determine a player combination for the second game, and determine whether a match exists between the player combination and the winning combination so that a known distinct portion of the jackpot prize associated with the distinct wager category and also with the second game is provided to the player. The criterion is a display of one or more symbols during play of the first game.

In yet another aspect of the disclosure, a process is provided. The process displays a plurality of distinct wager categories corresponding to play in a first game and a second game. Each of the distinct wager categories is associated with a known distinct portion of a jackpot prize associated with the second game. Further, the process displays a plurality of distinct paylines corresponding to prize payout in the first game. Each of the paylines indicates a distinct prize associated with a distinct symbol combination in the first game. In addition, the process establishes a criterion for the first game as a condition for the play in the second game. The criterion is independent of wager amount. The process also receives a selection of one of the distinct wager categories. Further, the process determines a wager based on the wager category that is selected. In addition, the process also receives a selection of at least a subset of the plurality of distinct paylines. The process also calculates the known distinct portion of the jackpot prize associated with the second game by multiplying a quantity of the distinct paylines in the subset of the plurality of distinct paylines with the wager. Further, the process initiates play of the first game. In addition, the process initiates, after the play of the first game, play of the second game if the criterion is met. The process also determines a winning combination for the second game. Further, the process determines a player combination for the second game. In addition, the process provides the known distinct portion of the jackpot prize associated with the distinct wager category and also with the second game if the player combination matches the winning combination.

In another aspect of the disclosure, an apparatus is provided. The apparatus has a display that displays a plurality of distinct wager categories corresponding to play in a first game and a second game. Each of the distinct wager categories is associated with a known distinct portion of a jackpot prize associated with the second game. Further, the apparatus has a wager input indicator that selects of one of the distinct wager categories. In addition, the apparatus has a payline input indicator that performs a selection of at least a subset of the plurality of distinct paylines. The apparatus also has a play input indicator that initiates play of the first game and initiates, after the play of the first game, play of the second game. Finally, the apparatus has one or more controllers that establish a criterion for the first game as a condition for the play in the second game, determine a wager based on the wager category that is selected, calculate the known distinct portion of the jackpot prize associated with the second game by multiplying a quantity of the distinct paylines in the subset of the plurality of distinct paylines with the wager, determine a winning combination for the second game, determine a player combination for the second game, and determine whether a match exists between the player combination and the winning combination so that a known distinct portion of the jackpot prize associated with the distinct wager category and also with the second game is provided to the player. The criterion is independent of wager amount.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates progressive slot system that can be utilized to implement the base game and the bonus game.

FIG. 2 illustrates an expanded view of the first base game-bonus game station shown in FIG. 1.

FIG. 3 illustrates a process that may be utilized to transition from play of the first game to play of the second game.

FIG. 4 illustrates a process that may be utilized in providing play of the base game in conjunction with the bonus game.

FIG. 5 illustrates a computing environment that may be utilized to implement the base game in conjunction with the bonus game.

### DETAILED DESCRIPTION

A method and apparatus are disclosed that allow a player of a base game to enter a bonus round without having made the maximum wager in the base game. The player can then win a portion of the progressive jackpot prize in the bonus game based on the wager category selected by the player in the base game. Accordingly, players that would normally be discouraged from playing the base game are now given an opportunity to be eligible for the bonus game. In other words, the criterion for entry into the bonus game is wager amount independent, as will be discussed below, so that all players have a chance at entering the bonus round. Further, the game provider is also incentivized as the players that make wagers from the lower wager categories are only provided with a portion of the progressive jackpot in the bonus round. The base game described herein is at times referred to as the first game, and the bonus game described herein is at times referred to as the second game.

The method and apparatus can be utilized with a variety of games. The base game and bonus game can be selected from games such as slots, poker, blackjack, bingo, etc. Further, the base game and the bonus game can be selected from games considered Class II or Class III. In one embodiment, the same type of game is utilized for both the base game and the bonus game, e.g., the base game is bingo and the bonus game is bingo. In another embodiment, different types of games are utilized for the base game and the bonus game, e.g., the base game is poker and the bonus game is bingo. A class III game can even be utilized for the base game while a class II game is utilized for the bonus game.

Further, the method and apparatus can be provided by a game provider in a variety of contexts. For example, the method and apparatus are utilized in a casino. The method and apparatus can also be utilized in locations, other than casinos, in which games are provided and wagers are received. The method and apparatus can even be provided virtually through a network, such as the Internet.

A win in either the base game or the bonus game is generally determined by a matching of some combination of symbols. A player combination of symbols is determined for the combination of symbols utilized by the player. The player combination may be selected by the player, randomly generated, or pre-established. Further, a wining combination of symbols is the combination of symbol that yields a win in the base game or the bonus game. The winning combination of symbols may be randomly generated or pre-established.

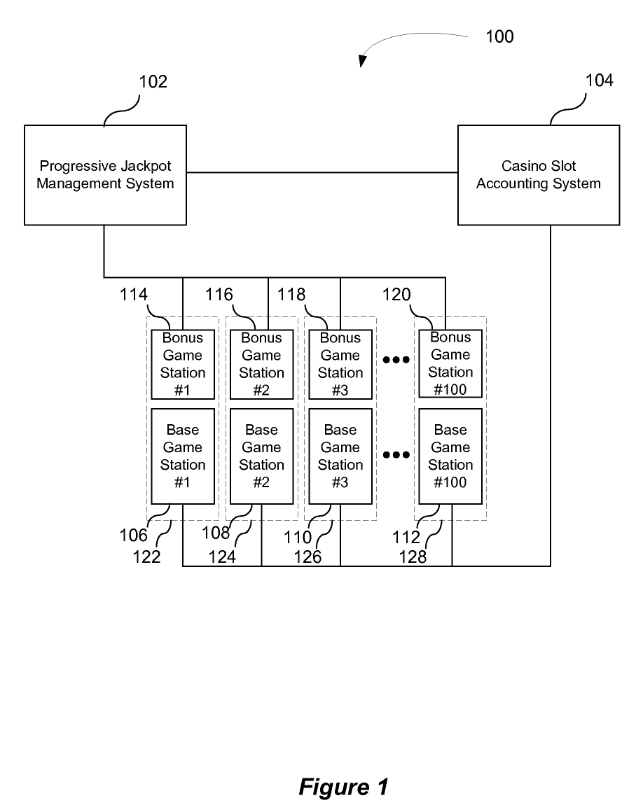

FIG. 1 illustrates progressive slot system 100 that can be utilized to implement the base game and the bonus game. The casino implementation is provided merely as an example and is not intended to limit use of the method and apparatus to that context as the method and apparatus can be utilized in any context in which a game provider provides games electronically, mechanically, virtually, or the like. Mechanical slot machines, stations displaying electronic slot games, video lottery terminals (“VLTs”), computers accessing electronic versions of the game through the Internet, etc., can be utilized to play the base game in conjunction with the bonus game according to the method and apparatus described herein.

The casino may have a plurality of base game stations, e.g., a first base game station 106, a second base game station 108, a third base game station 110, . . . , a one hundredth base game station 112. These base game stations may be utilized to provide players with the base game. In a casino setting, the base game can be any of the conventional casino games. The base game can even be a non-conventional casino game. In one embodiment, a casino slot accounting system 104 is utilized to monitor the activities of the plurality of base game stations.

Further, the casino may have a plurality of bonus game stations, e.g., a first bonus game station 114, a second bonus game station 116, a third bonus game station 118, . . . , a one hundredth bonus game station 120. These bonus game stations may be utilized to provide players with the bonus game. In a casino setting, the bonus game can be any of the conventional casino games or potentially a non-conventional casino game that is utilized for play with the conventional casino base game. Alternatively, both the bonus game and the base game can be non-conventional casino games. In one embodiment, the prize for the bonus game is a progressive jackpot, which accumulates in size based on wagers from players of the base game. A progressive jackpot management system may be utilized to manage the bonus game stations.

In one embodiment, a bonus game station is operably connected to a base game station to allow for play of the base game and the bonus game. The connection may be through cable, wireless communication, network connection, or the like. In one embodiment, casinos or other game providers can utilize existing base game stations and attach the bonus game station without having to reconfigure the bonus game station. Further, each of the bonus game stations can even be attached to different types of base game stations. For example, the first bonus game station 114 and the second bonus game station 116 may both provide a bingo game and provide a prize from the same progressive jackpot, but the first bonus game station 114 may be attached to the first base game station 106, which provides a video poker game, and the second bonus game station 116 may be attached to the second base game station 108, which provides a spinning reels game. Even though the base games are different, the wagers from both of these base games are contributed to the progressive jackpot of the bonus game. In one embodiment, a separate printer is implemented in the bonus game station to allow a winner of the bonus game to cash out separately from any potential winnings in the base game. This configuration helps provide compatibility of the bonus game station with different types of base game stations.

In another embodiment, the bonus game station and the base game station can be implemented on one device. For example, a machine with a single monitor can be utilized to play electronic versions both games. The same type of game, e.g., bingo for the base game and bingo for the bonus game, with different prizes may even be utilized.

Irrespective of the type of configuration or connection that is utilized, a plurality of base game-bonus game stations may be utilized by a casino or other game provider to provide the combination of the base game and the bonus game. For example, a first base game-bonus game station 122 includes the first base game station 106 and the first bonus game station 114, a second base game-bonus game station 124 includes the second base game station 108 and the second bonus game station 116, a third base game-bonus game station 126 includes the third base game station 110 and the third bonus game station 118, . . . , a one hundredth base game-bonus game station 128 includes the one hundredth base game station 112 and the one hundredth bonus game station 120.

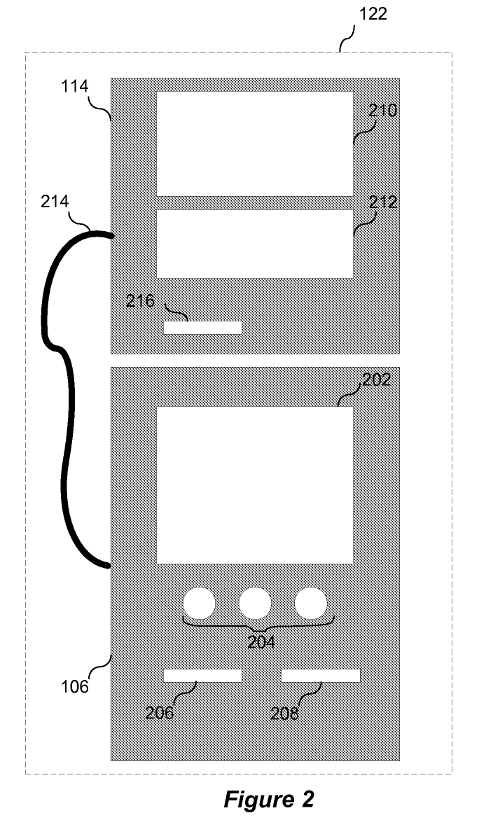

FIG. 2 illustrates an expanded view of the first base game-bonus game station 122 shown in FIG. 1. The first base game station 106 includes a display 202 in which play of the base game can be viewed. The display 202 may be an electronic display, an assortment of mechanical reels, etc. Further, the first base game station 106 has a plurality of buttons 204 that may be utilized to select a wager category, select a payline, initiate play of the base game and/or bonus game, etc. Further, the first base game station 106 has a wager acceptor 206, e.g., a bill acceptor, coin acceptor, promotional voucher acceptor, credit card acceptor, debit card acceptor, etc., that accepts a wager from the player. In addition, the first base game station 106 has a ticket printer 208 that may be utilized to print a ticket to redeem a prize. In one embodiment, the ticket is solely for a prize won in the base game. In another embodiment, the ticket may be for a prize won in the base game and/or a prize won in the bonus game.

The display 202 may be utilized to perform functions in addition to play of the bonus game. For instance, the display 202 may display a plurality of distinct wager categories prior to play of the base game. The distinct wager categories may be multiples of a minimum wager, which may also be displayed on the display 202. For example, the wager categories may be “one x”, “two x”, “three x”, “four x”, and “five x” of a minimum wager of one dollar. The actual wager is then determined by the wager category selected by the player. For example, a wager of three dollars is made if the player selects the wager category “three x.” The wager categories may also be denominations, i.e., fractions, of a maximum wager. For example, the wager categories may be “one-fifth,” “two-fifths,” “three-fifths,” “four-fifths,” and “five-fifths” of a maximum wager of five dollars. For example, a wager of two dollars is made if a player selects the wager category “two-fifths.” The wager categories may also state the wagers directly. For example, the wager categories may be “one dollar,” “two dollars,” “three dollars,” “four dollars,” and “five dollars.” A variety of other wager displays may be utilized to provide the wager categories.

Further, the display 202 may also indicate the known jackpot prize for the bonus game. The selection of the wager category not only has an impact on the base game, but also the bonus game. The wager category corresponds to a known portion of the progressive jackpot prize that can be potentially won. The portion can be a percentage, numerical amount, etc. For instance, a wager category of “one x” may correspond to the possibility of winning twenty percent of the jackpot prize in the bonus game, a wager category of “two x” may correspond to the possibility of winning forty percent of the jackpot prize in the bonus game, a wager category of “three x” may correspond to the possibility of winning sixty percent of the jackpot prize in the bonus game, a wager category of “four x” may correspond to the possibility of winning eighty percent of the jackpot prize in the bonus game, and a wager category of “five x” may correspond to the possibility of winning one hundred percent of the jackpot prize in the bonus game. If the player becomes eligible for the bonus round, the known portion of the progressive jackpot prize associated with the wager category can be displayed.

In one embodiment, the base game offers a variety of prizes such as fixed prizes that depend on obtaining a predetermined assortment of symbols. Accordingly, a set of paylines is provided to indicate which fixed prizes are associated with particular paylines. For example, a payline may indicate that obtaining a row of cherries yields a fixed prize of five dollars while another payline may indicate that obtaining a diagonal of oranges yields a fixed prize of ten dollars. Another function that may be performed by the display 202 is providing a display of paylines. A player may select a particular payline, some of the paylines, or all of the paylines for play in the base game. In one embodiment, the number of paylines is a multiplier of the wager determined by the selection of the wager categories and can be utilized to determine the known distinct portion of the progressive jackpot prize that can be won in the bonus game.

Functions such as the display of the plurality of distinct wager categories or display of the paylines can also be provided through other components of the first base game-bonus game station 122. For instance, a printed game glass can be positioned at on the first base game-bonus game station 122 to display this information. Alternatively, a display 210 that is utilized by the bonus game station 114 to display play of the bonus game may be utilized to display this information. In yet another alternative, a display 212, which is utilized to display jackpot prize information for the bonus game, may display this information.

In one embodiment, play of the bonus game is wager amount independent. In other words, eligibility for play in the bonus round is based on factors other than the wager amount. The wager amount has an impact on the known portion of the jackpot prize that can be won in the bonus round, but does not impact the entry into the bonus game. For example, a criterion can be established to provide that play of the bonus game is dependent on a display of particular symbols in the base game, whether or not there is a win in the base game. For instance, the criterion may be a display pattern such as two consecutive cherries displayed anywhere during play of the base game. The criterion may be a game count. In other words, every fiftieth play of the base game at a particular base game station provides eligibility into the bonus game.

If the player is eligible to enter the bonus game, the bonus game is displayed for play on the display 210. This configuration is provided as an example as the base game and bonus game could be played on the same display. In this configuration, the first bonus game station 114 is operably connected to the first base game station 106 through a cable 214. Accordingly, data from the base game, e.g., wager category selected by the player, can be provided to the first bonus game station 114. In one embodiment, the cable (or other communication medium) provides two-way communication between the first bonus game station 114 and the first base game station 106 such that the bonus game station 114 can provide information regarding the progressive jackpot to be displayed by the first base game station 106 and the first base game station 106 can provide information regarding the wager categories to the first game bonus station 114 to be displayed by the first game bonus station 114. However, in another embodiment, the one-way communication can be established such that the first bonus game station 114 only receives information from the first base game station 106. For instance, the first bonus game station 114 can receive information regarding the wager categories. Further, the first bonus game station 114 can display the progressive jackpot on the display 212 along with the wager categories. Therefore, a player can view a top display of the potential portions of the jackpot prize corresponding to wager categories that are applicable to play in the base game and the bonus game.

After play of the bonus game is initiated, the display 212 can also display the wager categories and corresponding levels of the jackpot prize that can be won with each wager category. In addition, the display 212 can indicate the level of the jackpot prize that the player can potentially win. This indication may be provided as a percentage of the jackpot prize, the numerical amount that would be received, etc. Alternatively, only the actual level of the jackpot prize that can be potentially won, without the other levels of the jackpot prize that are no longer applicable, is displayed play of the bonus game is initiated.

The first bonus game station 116 does not need to have a wager acceptor as the wager acceptor utilized in the first base game station 106 receives a wager that is applicable to both the base game and the bonus game. In one embodiment, the first bonus game station 116 includes a ticket printer 216 to print a ticket so that the portion of the progressive jackpot prize that is won can be redeemed. In another embodiment, the ticket printer 206 utilized by the first base game station 106 may be utilized to print tickets for prize redemption in both the base game and the bonus game.

In one embodiment, one or more controllers may be utilized to perform functions such as initiating play of the games. For instance, the first base game station 106 may have a controller for initiating play of the base game, and the first bonus game station 116 may have a controller for initiating play of the bonus game.

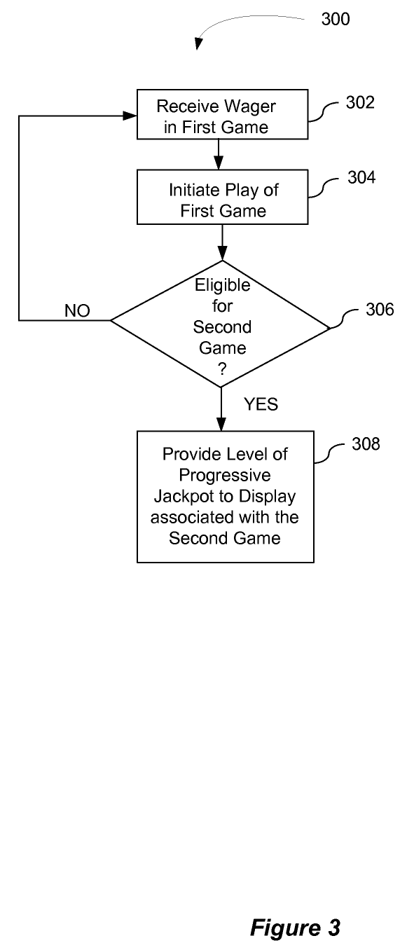

FIG. 3 illustrates a process 300 that may be utilized to transition from play of the first game to play of the second game. At a process block 302, the process 300 receives a wager in the first game. Further, at a process block 304, the process 300 initiates play of the first game. In addition, at a decision block 306, the process 300 determines if the player is eligible for the second game. In one embodiment, a criterion that is wager amount independent, as discussed above, can be utilized to determine the player's eligibility for the second game. In another embodiment, the games may be configured so that a player of the first game is always eligible for the second game. If the player is not eligible for the second game, the process 300 proceeds to the process block 302 to receive another wager in the first game from the same player or a different player. If the player is eligible for the second game, the process 300 proceeds to a process block 308 to provide the level of the progressive jackpot associated with the wager category selected by the player to the display associated with the second game.

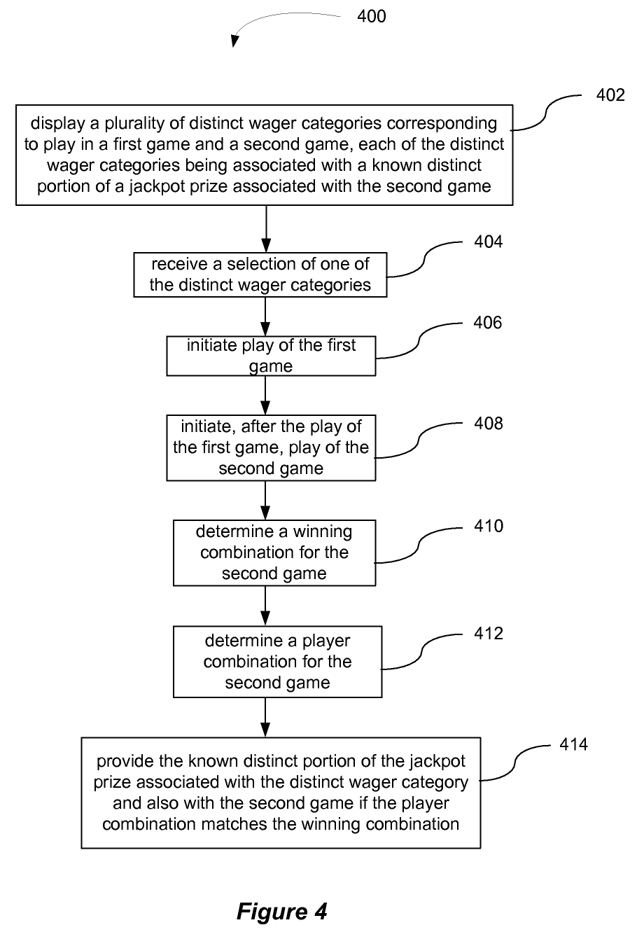

FIG. 4 illustrates a process 400 that may be utilized in providing play of the base game in conjunction with the bonus game. At a process block 402, the process 400 displays a plurality of distinct wager categories corresponding to play in a first game and a second game. Each of the distinct wager categories is associated with a known distinct portion of a jackpot prize associated with the second game. Further, at a process block 404, the process 400 receives a selection of one of the distinct wager categories. In addition, at a process block 406, the process 400 initiates play of the first game. At a process block 408, the process also initiates, after the play of the first game, play of the second game. Further, at a process block 410, the process 400 determines a winning combination for the second game. In addition, at a process block 412, the process 400 determines a player combination for the second game. Finally, at a process block 414, the process 400 provides the known distinct portion of the jackpot prize associated with the distinct wager category and also with the second game if the player combination matches the winning combination.

In one embodiment, the method and apparatus as discussed above can be implemented with a constant ratio based system. For example, a player can make a one dollar wager in the hope of winning a portion of the progressive jackpot that equals twenty percent. The player can also make a two dollar wager in the hope of winning a portion of the progressive jackpot that equals forty percent. A first association between the wager of one dollar and the percentage of twenty percent can be the quotient of twenty divided by one, which equals twenty. Similarly, a second association between the wager of two dollars and the percentage of forty percent can be the quotient of forty divided by two, which equals twenty. A constant ratio exists when the first association equals the second association. The potential portion of the jackpot prize is basically multiplied by the multiple of the lower wager that yields the higher wager.

In another embodiment, the method and apparatus as discussed above can be implemented with a variable ratio based system. For example, a player can make a one dollar wager in the hope of winning a portion of the progressive jackpot that equals twenty percent. The player can also make a two dollar wager in the hope of winning a portion of the progressive jackpot that equals forty five percent. A first association between the wager of one dollar and the percentage of twenty percent can be the quotient of twenty divided by one, which equals twenty. However, a second association between the wager of two dollars and the percentage of forty percent can be the quotient of forty five divided by two, which equals twenty two and one half. A variable ratio exists because the first association does not equal the second association. The variable ratio provides incentive to the player to make the higher wager because the potential portion of the jackpot prize is basically multiplied by a multiple that is larger than the multiple of the lower wager. As a result, the variable ratio provides the player with the ability to potentially win more for a wager than would be ordinarily won with a constant ratio.

In one embodiment, a game provider can provide an added level of excitement by associating the selected wager category with a particular character or symbol. The character or symbol can then be utilized throughout play of the base game and the bonus game.

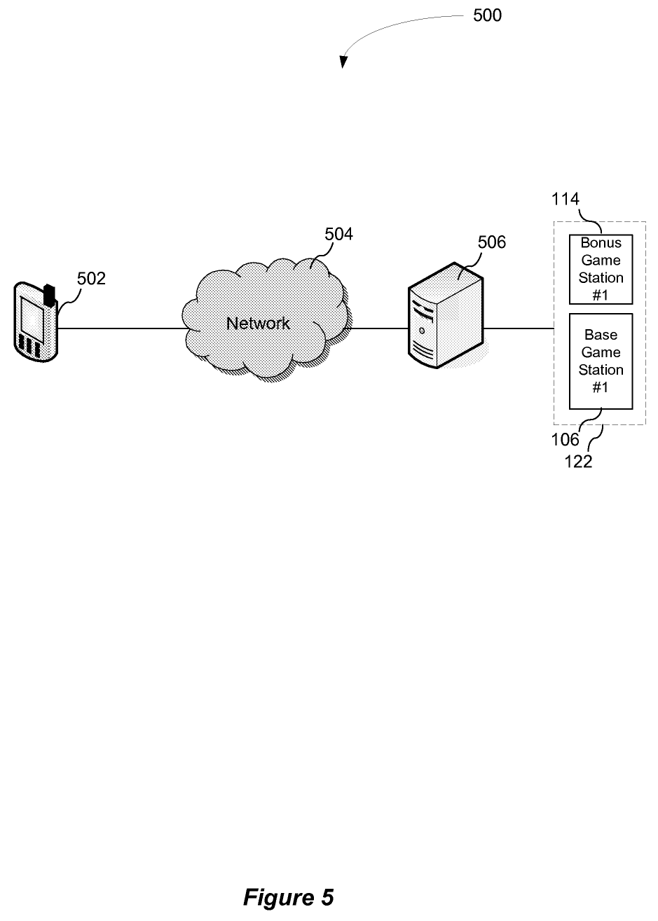

FIG. 5 illustrates a computing environment 500 that may be utilized to implement the base game in conjunction with the bonus game. An input device 502 may be utilized by a player to play the base game in conjunction with the bonus game. The input device 502 may be a PC connected to the Internet, a mobile phone, a personal digital assistant (“PDA”), a media player, or the like. Further, the player may utilize the input device 502 to communicate through a network 504 such as the Internet, a local area network (“LAN”), a wide area network (“WAN”), a mobile network, a proprietary network, or the like. The network 504 allows the input device 502 to communicate with a gaming server 506. The gaming server 506 is basically a conduit to a base game-bonus game station such as the first base game-bonus game station 122. In one embodiment, the input device 502 communicates with the game server 506 through the network 504 to the first base game station 106 in the first base game-bonus game station 122. If the bonus game is reached, the first bonus game station 114 may communicate back to the input device 502 through the game server 506 and the network 504, or the first base game station 106 may communicate data for the first bonus game station 114.

In one embodiment, the combination of the base game and the bonus game can be provided in a podcast to the input device 502. The player may subscribe to a feed for a particular type of content. The game provider may make a business arrangement with the content provider of that content such that the combination of the base game and the bonus game are pushed to the input device 502 along with the other content. The player can become aware of and play the base game in conjunction with the bonus game when viewing the content in the podcast.

It is understood that the method and apparatus described herein may also be applied in other types of systems. Those skilled in the art will appreciate that the various adaptations and modifications of the embodiments of this method and apparatus may be configured without departing from the scope and spirit of the present method and system. Therefore, it is to be understood that, within the scope of the appended claims, the present method and apparatus may be practiced other than as specifically described herein.

We claim:

1. A method comprising:
displaying a plurality of distinct wager categories corresponding to play in a first game and a second game, each of the distinct wager categories being associated with a known distinct portion of a jackpot prize associated with the second game;
receiving a selection of one of the distinct wager categories;
initiating play of the first game;
initiating, after the play of the first game, play of the second game;
determining a winning combination for the second game;
determining a player combination for the second game; and
providing the known distinct portion of the jackpot prize associated with the distinct wager category and also with the second game if the player combination matches the winning combination.

2. The method of claim 1, wherein the determining the winning combination for the second game comprises randomly generating the winning combination.

3. The method of claim 1, wherein the determining the winning combination for the second game comprises selecting a pre-established combination.

4. The method of claim 1, wherein the determining the player combination for the second game comprises randomly generating the player combination.

5. The method of claim 1, wherein the determining the player combination for the second game comprises selecting a pre-established combination.

6. The method of claim 1, wherein the determining the player combination for the second game comprises receiving a combination from the player.

7. The method of claim 1, wherein the winning combination is an arrangement of symbols.

8. The method of claim 1, wherein the player combination is an arrangement of symbols.

9. The method of claim 1, wherein the distinct wager categories are multiples of a minimum wager.

10. The method of claim 1, wherein the distinct wager categories are denominations of a maximum wager.

11. The method of claim 1, further comprising establishing a criterion for the first game as a condition for the play in the second game.

12. The method of claim 11, wherein the criterion comprises a display of one or more symbols during play of the first game.

13. The method of claim 1, wherein the second game is bingo.

14. The method of claim 1, further comprising providing a fixed prize associated with the second game if part of the player combination matches the winning combination in the second game.

15. The method of claim 1, further comprising providing a known distinct portion of a fixed prized prize associated with the distinct wager category and also with the second game if part of the player combination matches the winning combination in the second game.

16. The method of claim 1, wherein a variable ratio exists between the distinct portions of the jackpot prize associated with at least two consecutively displayed distinct wager categories.

17. The method of claim 1, wherein a linear ratio exists between the distinct portions of the jackpot prize associated with at least two consecutively displayed distinct wager categories.

18. The method of claim 1, wherein the known distinct portion of the jackpot is a percentage of the jackpot prize.

19. The method of claim 1, wherein the jackpot prize is progressive.

20. The method of claim 1, wherein the first game is a game provided on a slot machine.

21. The method of claim 1, wherein the first game is a game provided on a video terminal.

22. The method of claim 21, wherein the first game is provided through a graphic of a slot machine on a display of the video terminal.

23. The method of claim 1, further comprising displaying the known distinct portion of the jackpot prize associated with the second game in a display corresponding to the first game prior to the initiating play of the second game.

24. The method of claim 1, wherein the first game provides one or more fixed prizes.

25. A method comprising:
displaying a plurality of distinct wager categories corresponding to play in a first game and a second game, each of the distinct wager categories being associated with a known distinct portion of a jackpot prize associated with the second game;
displaying a plurality of distinct paylines corresponding to prize payout in the first game, each of the paylines indicating a distinct prize associated with a distinct symbol combination in the first game;
receiving a selection of one of the distinct wager categories;
determining a wager based on the wager category that is selected;
receiving a selection of at least a subset of the plurality of distinct paylines;
calculating the known distinct portion of the jackpot prize associated with the second game by multiplying a quantity of the distinct paylines in the subset of the plurality of distinct paylines with the wager;
initiating play of the first game;
initiating, after the play of the first game, play of the second game;
determining a winning combination for the second game;
determining a player combination for the second game; and
providing the known distinct portion of the jackpot prize associated with the distinct wager category and also with the second game if the player combination matches the winning combination.

26. The method of claim 25, wherein the determining the wager is additionally based on an amount received from the player.

27. The method of claim 26, wherein the determining the wager is additionally based on the amount received from the player multiplied by the wager category that is selected.

28. The method of claim 25, further comprising establishing a criterion for the first game as a condition for the play in the second game.

29. The method of claim 28, wherein the criterion comprises a display of one or more symbols during play of the first game.

30. The method of claim 28, wherein the criterion comprises a game count.

31. The method of claim 28, wherein the criterion is independent of wager amount.

32. The method of claim 25, wherein the determining the winning combination for the second game comprises randomly generating the winning combination.

33. The method of claim 25, wherein the determining the winning combination for the second game comprises selecting a pre-established combination.

34. The method of claim 25, wherein the determining the player combination for the second game comprises randomly generating the player combination.

35. The method of claim 25, wherein the determining the player combination for the second game comprises selecting a pre-established combination.

36. The method of claim 25, wherein the determining the player combination for the second game comprises receiving a combination from the player.

37. A method comprising:
displaying a plurality of distinct wager categories corresponding to play in a first game and a second game, each of the distinct wager categories being associated with a known distinct portion of a jackpot prize associated with the second game;
displaying a plurality of distinct paylines corresponding to prize payout in the first game, each of the paylines indicating a distinct prize associated with a distinct symbol combination in the first game;
establishing a criterion for the first game as a condition for the play in the second game, the criterion being a display of one or more symbols during play of the first game;
receiving a selection of one of the distinct wager categories;
determining a wager based on the wager category that is selected;
receiving a selection of at least a subset of the plurality of distinct paylines;
calculating the known distinct portion of the jackpot prize associated with the second game by multiplying a quantity of the distinct paylines in the subset of the plurality of distinct paylines with the wager;
initiating play of the first game;
initiating, after the play of the first game, play of the second game if the criterion is met;
determining a winning combination for the second game;
determining a player combination for the second game; and
providing the known distinct portion of the jackpot prize associated with the distinct wager category and also with the second game if the player combination matches the winning combination.

38. The method of claim 37, wherein the determining the winning combination for the second game comprises randomly generating the winning combination.

39. The method of claim 37, wherein the determining the winning combination for the second game comprises selecting a pre-established combination.

40. The method of claim 37, wherein the determining the player combination for the second game comprises randomly generating the player combination.

41. The method of claim 37, wherein the determining the player combination for the second game comprises selecting a pre-established combination.

42. The method of claim 37, wherein the determining the player combination for the second game comprises receiving a combination from the player.

43. An apparatus comprising:
a display that displays a plurality of distinct wager categories corresponding to play in a first game and a second game, each of the distinct wager categories being associated with a known distinct portion of a jackpot prize associated with the second game;
a wager input indicator that selects of one of the distinct wager categories;
a play input indicator that initiates play of the first game and initiates, after the play of the first game, play of the second game; and
one or more controllers that determine a winning combination for the second game, a player combination for the second game, and whether a match exists between the player combination and the winning combination so that a known distinct portion of the jackpot prize associated with the distinct wager category and also with the second game is provided to the player.

44. The apparatus of claim 43, wherein the one or more controllers include one or more random number generators.

45. The apparatus of claim 43, wherein the one or more controllers are configured to select from pre-established combinations for the winning combination.

46. The apparatus of claim 43, wherein the one or more controllers are configured to select from pre-established combinations for the player combination.

47. The apparatus of claim 43, wherein the one or more controllers are configured to receive a player input for the player combination.

48. The apparatus of claim 43, further comprising a bill acceptor that receives, from the player, a wager based on the distinct wager category that is selected.

49. The apparatus of claim 43, further comprising a coin acceptor that receives, from the player, a wager based on the distinct wager category that is selected.

50. The apparatus of claim 43, further comprising a prepaid card acceptor that receives, from the player, a wager based on the distinct wager category that is selected.

51. The apparatus of claim 43, further comprising a promotional voucher acceptor that receives, from the player, a wager based on the distinct wager category that is selected.

52. The apparatus of claim 43, further comprising a credit card acceptor that receives, from the player, a wager based on the distinct wager category that is selected.

53. The apparatus of claim 43, further comprising a debit card acceptor that receives, from the player, a wager based on the distinct wager category that is selected.

54. The apparatus of claim 43, wherein the one or more controllers also establish a criterion for the first game as a condition for the play in the second game.

55. The apparatus of claim 54, wherein the criterion comprises a display of one or more symbols during play of the first game.

56. The apparatus of claim 54, wherein the criterion comprises a game count.

57. The apparatus of claim 54, wherein the criterion is independent of wager amount.

58. The apparatus of claim 54, wherein the first game provides one or more fixed prizes.

59. An apparatus comprising:
a display that displays a plurality of distinct wager categories corresponding to play in a first game and a second game, each of the distinct wager categories being associated with a known distinct portion of a jackpot prize associated with the second game;
a wager input indicator that selects of one of the distinct wager categories;
a payline input indicator that performs a selection of at least a subset of the plurality of distinct paylines;
a play input indicator that initiates play of the first game and initiates, after the play of the first game, play of the second game; and
one or more controllers that determine a wager based on the wager category that is selected, calculate the known distinct portion of the jackpot prize associated with the second game by multiplying a quantity of the distinct paylines in the subset of the plurality of distinct paylines with the wager, determine a winning combination for the second game, determine a player combination for the second game, and determine whether a match exists between the player combination and the winning combination so that a known distinct portion of the jackpot prize associated with the distinct wager category and also with the second game is provided to the player.

60. The apparatus of claim 59, wherein the one or more controllers include one or more random number generators.

61. The apparatus of claim 59, wherein the one or more controllers are configured to select from pre-established combinations for the winning combination.

62. The apparatus of claim 59, wherein the one or more controllers are configured to select from pre-established combinations for the player combination.

63. The apparatus of claim 59, wherein the one or more controllers are configured to receive a player input for the player combination.

64. An apparatus comprising:
a display that displays a plurality of distinct wager categories corresponding to play in a first game and a second game, each of the distinct wager categories being associated with a known distinct portion of a jackpot prize associated with the second game;
a wager input indicator that selects of one of the distinct wager categories;
a payline input indicator that performs a selection of at least a subset of the plurality of distinct paylines;
a play input indicator that initiates play of the first game and initiates, after the play of the first game, play of the second game; and
one or more controllers that establish a criterion for the first game as a condition for the play in the second game, determine a wager based on the wager category that is selected, calculate the known distinct portion of the jackpot prize associated with the second game by multiplying a quantity of the distinct paylines in the subset of the plurality of distinct paylines with the wager, determine a winning combination for the second game, determine a player combination for the second game, and determine whether a match exists between the player combination and the winning combination so that a known distinct portion of the jackpot prize associated with the distinct wager category and also with the second game is provided to the player, the criterion being a display of one or more symbols during play of the first game.

65. The apparatus of claim 64, wherein the one or more controllers include one or more random number generators.

66. The apparatus of claim 64, wherein the one or more controllers are configured to select from pre-established combinations for the winning combination.

67. The apparatus of claim 64, wherein the one or more controllers are configured to select from pre-established combinations for the player combination.

68. The apparatus of claim 64, wherein the one or more controllers are configured to receive a player input for the player combination.

69. A method comprising:
displaying a plurality of distinct wager categories corresponding to play in a first game and a second game, each of the distinct wager categories being associated with a known distinct portion of a jackpot prize associated with the second game;
displaying a plurality of distinct paylines corresponding to prize payout in the first game, each of the paylines indicating a distinct prize associated with a distinct symbol combination in the first game;
establishing a criterion for the first game as a condition for the play in the second game, the criterion being independent of wager amount;
receiving a selection of one of the distinct wager categories;
determining a wager based on the wager category that is selected;
receiving a selection of at least a subset of the plurality of distinct paylines;
calculating the known distinct portion of the jackpot prize associated with the second game by multiplying a quantity of the distinct paylines in the subset of the plurality of distinct paylines with the wager;
initiating play of the first game;
initiating, after the play of the first game, play of the second game if the criterion is met;
determining a winning combination for the second game;
determining a player combination for the second game; and
providing the known distinct portion of the jackpot prize associated with the distinct wager category and also with the second game if the player combination matches the winning combination.

70. An apparatus comprising:
a display that displays a plurality of distinct wager categories corresponding to play in a first game and a second game, each of the distinct wager categories being associated with a known distinct portion of a jackpot prize associated with the second game;
a wager input indicator that selects of one of the distinct wager categories;
a payline input indicator that performs a selection of at least a subset of the plurality of distinct paylines;
a play input indicator that initiates play of the first game and initiates, after the play of the first game, play of the second game; and
one or more controllers that establish a criterion for the first game as a condition for the play in the second game, determine a wager based on the wager category that is selected, calculate the known distinct portion of the jackpot prize associated with the second game by multiplying a quantity of the distinct paylines in the subset of the plurality of distinct paylines with the wager, determine a winning combination for the second game, determine a player combination for the second game, and determine whether a match exists between the player combination and the winning combination so that a known distinct portion of the jackpot prize associated with the distinct wager category and also with the second game is provided to the player, the criterion being independent of wager amount.
